(19) United States
(12) Patent Application Publication
(10) Pub. No.: US 2018/0163471 A1
(43) Pub. Date: Jun. 14, 2018

(54) Pinch Flex Latch, Ladder and Method

(71) Applicant: Tek Lentine, Greenville, PA (US)

(72) Inventor: Tek Lentine, Greenville, PA (US)

(21) Appl. No.: 15/375,996

(22) Filed: Dec. 12, 2016

(51) Int. Cl. E06C 7/50; E06C 1/16; F16B 45/00

(52) U.S. Cl. CPC E06C 7/50; F16B 45/00; E06C 1/16

(57) ABSTRACT

A latch for latching a first object with a second object includes a catch attached to the first object. The latch includes a hook portion having a hook which engages with the catch attached to the first object that the latch holds in place. The latch includes a base portion that is fixed to a rigid surface of the second object. The ladder includes a pinch flex portion connected to the base portion and the hook portion. When the pinch flex portion is compressed or pinch flexed downward to the base portion, the hook portion moves off of the first object, thus releasing the first object to move away from the second object. When the first object is to be held or latched to the second object, the first object is moved against a cam portion of the hook portion, pushing the hook portion back away from the first object until the first object clears the hook of the hook portion, whereupon the hook portion no longer being restrained by the first object, under a force bias created in the pinch flex portion by the pinch flex portion being compressed, automatically moves back and catches or latches the first object to the second object without any spring or other component to create the force bias. The latch is one piece. A method for latching a first object to a second object, such as a front rail and a rear rail of a ladder. A ladder.

### FIELD OF THE INVENTION

The present invention pertains to a one-piece latch attached to a first object that engages with a catch attached to a second object to latch the first object to the second object. (As used herein, references to the “present invention” or “invention” relate to exemplary embodiments and not necessarily to every embodiment encompassed by the appended claims.) More specifically, the present invention pertains to a one-piece latch attached to a first object that engages with a catch attached to a second object to latch the first object to the second object where the latch has a cam portion against which the second object pushes against as it moves toward the first object, and after clearing the cam portion a hook portion of the latch automatically engages with the catch to latch the first object with the second object.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

In a multitude of instances where a first object and a second object removably attach to each other, there is a need to securely hold the first object and second object together in certain positions. For instance, when a step ladder is moved into an open position, it is desired to latch in place a front portion or platform to a rear portion of the ladder, so the ladder can be maintained in a open or use position and a user's hand safely climb the stepladder without concern that the stepladder will collapse. Simple latches are manually moved by a user into place when the first object and second object are in a desired position. More complex latches have some type of biasing force, such as a spring, incorporated into them so that the latch automatically latches the first object and second object together without the user having to manually move the latch whatsoever. The more complex latches with more components and weight because of the presence of more components, an increase the likelihood of failure in the sense that there are more components to fail. For certain applications, it would be desirable to have a latch which automatically biases to latch a first object and a second object when they are brought together.

### BRIEF SUMMARY OF THE INVENTION

The present invention pertains to a latch for latching a first object with a second object. The latch comprises a catch attached to the first object. The latch comprises a hook portion having a hook which engages with the catch attached to the first object that the latch holds in place. The latch comprises a base portion that is fixed to a rigid surface of the second object. The ladder comprises a pinch flex portion connected to the base portion and the hook portion. When the pinch flex portion is compressed or pinch flexed downward to the base portion, the hook portion moves off of the first object, thus releasing the first object to move away from the second object. When the first object is to be held or latched to the second object, the first object is moved against a cam portion of the hook portion, pushing the hook portion back away from the first object until the first object clears the hook of the hook portion, whereupon the hook portion no longer being restrained by the first object, under a force bias created in the pinch flex portion by the pinch flex portion being compressed, automatically moves back and catches or latches the first object to the second object without any spring or other component to create the force bias. The latch is one piece.

The present invention pertains to a method for latching a first object with a second object. The method comprises the steps of compressing a pinch flex portion of a latch downward toward a base portion of the latch that is fixed to a rigid surface of the second object causing a hook portion of the latch to move off of a catch attached to the first object, thus releasing the first object to move away from the second object. The pinch flex portion connected to the base portion and the hook portion. There is the step of moving the first object away from the second object. There is the step of moving the first object against a cam portion of the hook portion, which pushes the hook portion back away from the first object until the first object clears the hook of the hook portion, whereupon the hook portion no longer being restrained by the first object, under a force bias created in the pinch flex portion by the pinch flex portion being compressed, automatically moves back and catches or latches the first object to the second object without any spring or other component to create the force bias. The latch is one piece.

The present invention pertains to a ladder. The ladder comprises a front rail. The ladder comprises a rear rail. The ladder comprises a step attached to the front rail. The ladder comprises a latch attached to the rear rail and positioned on the rear rail so when the ladder is in a folded position, the latch latches with the step. The latch comprises a hook portion having a hook which engages with the step attached to the front rail that the latch holds in place. The latch comprises a base portion that is fixed to a rigid surface of the rear rail. The latch comprises a pinch flex portion connected to the base portion and the hook portion. When the pinch flex portion is compressed or pinch flexed downward to the base portion, the hook portion moves off of the step attached to the front rail, thus releasing the front rail to move away from the rear rail. When the front rail is to be held or latched to the rear rail, the step of the front rail is moved against a cam portion of the hook portion, pushing the hook portion back away from the step of the front rail until the front rail clears the hook of the hook portion, whereupon the hook portion no longer being restrained by the step of the front rail, under a force bias created in the pinch flex portion by the pinch flex portion being compressed, automatically moves back and catches or latches the front rail to the rear rail without any spring or other component to create the force bias/The latch is one piece.

The present invention pertains to a method for latching a front rail of a ladder with a rear rail of the ladder. The method comprises the steps of compressing a pinch flex portion of a latch downward toward a base portion of the latch that is fixed to a rigid surface of the rear rail causing a hook portion of the latch to move off of a step attached to the front rail, thus releasing the front rail to move away from the rear rail. The pinch flex portion is connected to the base portion and the hook portion. There is the step of moving the front rail away from the rear rail. There is the step of moving the step of the front rail, against a cam portion of the hook portion, which pushes the hook portion back away from the step of the front rail until the step of the front rail clears the hook of the hook portion, whereupon the hook portion no longer being restrained by the step of the front rail, under a force bias created in the pinch flex portion by the pinch flex portion being compressed by the step, automatically moves back and catches or latches the step and thus the front rail to the rear rail without any spring or other component to create the force bias. The latch is one piece.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a representation of the latch of the present invention.

FIG. 2 shows a perspective view of the latch.

FIG. 3 shows a side view of the latch attached to a rear rail of a ladder.

FIG. 4 shows a side view of a ladder of the present invention in a folded position.

FIG. 5 shows a side view of the ladder in the open position.

FIG. 6 shows a front view of the latch.

FIG. 7 shows a side view of the latch.

FIG. 8 shows an overhead view of the latch.

FIG. 9 shows a rear view of the latch.

### DETAILED DESCRIPTION OF THE INVENTION

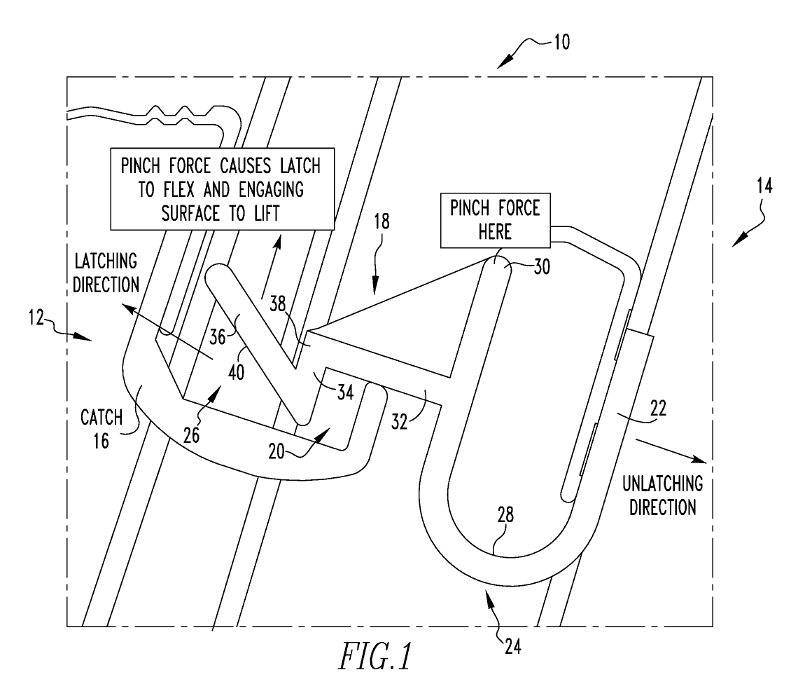

Referring now to the drawings wherein like reference numerals refer to similar or identical parts throughout the several views, and more specifically to FIG. 1 thereof, there is shown a latch 10 for latching a first object 12 with a second object 14. The latch 10 comprises a catch 16 attached to the first object 12. The latch 10 comprises a hook portion 18 having a hook 20 which engages with the catch 16 attached to the first object 12 that the latch 10 holds in place. The latch 10 comprises a base portion 22 that is fixed to a rigid surface of the second object 14. The ladder 48 comprises a pinch flex portion 24 connected to the base portion 22 and the hook portion 18. When the pinch flex portion 24 is compressed or pinch flexed downward to the base portion 22, the hook portion 18 moves off of the first object 12, thus releasing the first object 12 to move away from the second object 14. When the first object 12 is to be held or latched to the second object 14, the first object 12 is moved against a cam portion 26 of the hook portion 18, pushing the hook portion 18 back away from the first object 12 until the first object 12 clears the hook 20 of the hook portion 18, whereupon the hook portion 18 no longer being restrained by the first object 12, under a force bias created in the pinch flex portion 24 by the pinch flex portion 24 being compressed, automatically moves back and catches or latches the first object 12 to the second object 14 without any spring or other component to create the force bias. The latch 10 is one piece. The material for the latch may be a bendable plastic, such as Delrin 127 UV NC010, which is an acetal resin.

The pinch flex portion 24 may have a loop 28 and a free end 30 that together form a U shape with the base portion 22. The free end 30 extending from the loop 28 which is able to move up and down and essentially in parallel with the base portion 22. When a compressive force is applied to the free end 30, the free end 30 moves down towards the base portion 22 pivoting at the loop 28. The hook portion 18 may extend outward away from the base portion 22 essentially perpendicularly from the free end 30.

The hook portion 18 may include a first element 32 attached to and extending essentially perpendicularly from the free end 30 outward away from the free end 30, a second element 34 attached at a connection point 38 to the first element 32 extending essentially perpendicularly from the first element 32 and in parallel with the free end 30, and a third element 36 attached to the second element 34 extending outward at an acute angle away from the second element 34 and back toward the connection point 38 between the first element 32 in the second element 34 to define a slope 40. The third element 36 may be the cam portion 26 against which the catch 16 pushes back as the first object 12 is moved toward the second object 14 until the catch 16 moves down the slope 40 and clears the second element 34, whereupon the second element 34 moves back over the catch 16, the second element 34 and first element 32 forming the hook 20.

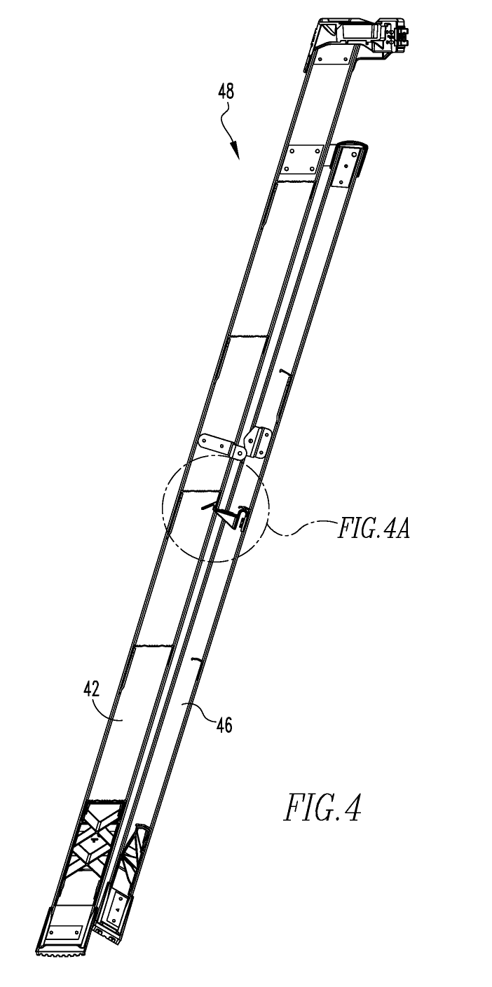

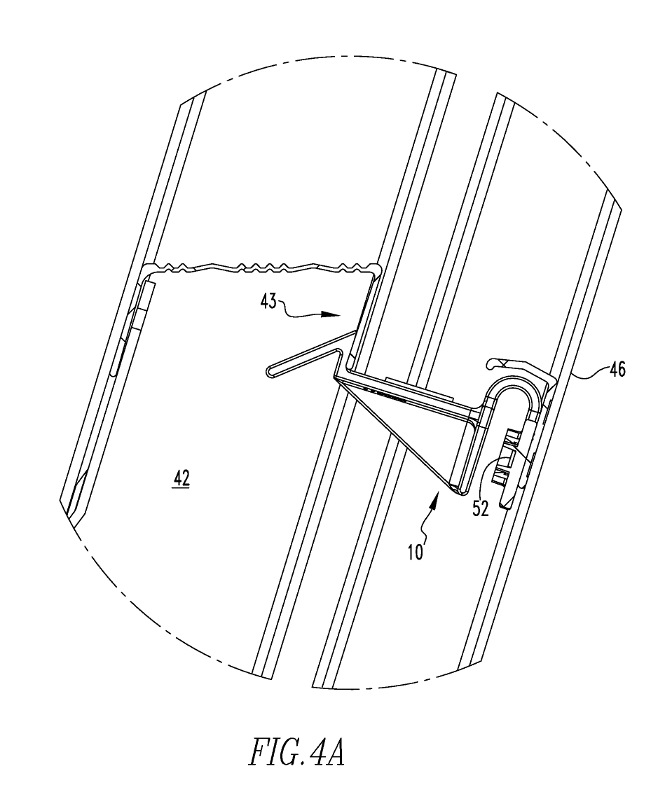

The first object may be a front rail 42 of a ladder 48, as shown in FIGS. 4 and 5, and the second object may be the rear rail 46 of the ladder 48. FIG. 4 shows the ladder 48 in the folded position with the latch 10 engaged with the catch 16, which in this embodiment is a step 43 attached to the inside of the front rail 42. When the ladder 48 is in the folded position, the latch 10 on the inside of the rear rail is aligned with the step attached to the front rail 42 to latch with the step 43. FIG. 5 shows a ladder 48 in the open position for use.

The present invention pertains to a method for latching a first object 12 with a second object 14. The method comprises the steps of compressing a pinch flex portion 24 of a latch 10 downward toward a base portion 22 of the latch 10 that is fixed to a rigid surface of the second object 14 causing a hook portion 18 of the latch 10 to move off of a catch 16 attached to the first object 12, thus releasing the first object 12 to move away from the second object 14. The pinch flex portion 24 connected to the base portion 22 and the hook portion 18. There is the step of moving the first object 12 away from the second object 14. There is the step of moving the first object 12 against a cam portion 26 of the hook portion 18, which pushes the hook portion 18 back away from the first object 12 until the first object 12 clears the hook 20 of the hook portion 18, whereupon the hook portion 18 no longer being restrained by the first object 12, under a force bias created in the pinch flex portion 24 by the pinch flex portion 24 being compressed, automatically moves back and catches or latches the first object 12 to the second object 14 without any spring or other component to create the force bias. The latch 10 is one piece.

The present invention pertains to a ladder 48, as shown in FIGS. 4 and 5. The ladder 48 comprises a front rail 42. The ladder 48 comprises a rear rail 46. The ladder 48 comprises a step 43 attached to the front rail 42. The ladder 48 comprises a latch 10 attached to the rear rail 46 and positioned on the rear rail 46 so when the ladder 48 is in a folded position, the latch 10 latches with the step 43. The latch 10 comprises a hook portion 18 having a hook 20 which engages with the step 43 attached to the front rail 42 that the latch 10 holds in place. The latch 10 comprises a base portion 22 that is fixed to a rigid surface of the rear rail 46. The latch 10 comprises a pinch flex portion 24 connected to the base portion 22 and the hook portion 18. When the pinch flex portion 24 is compressed or pinch flexed downward to the base portion 22, the hook portion 18 moves off of the step 43 of the front rail 42, thus releasing the front rail 42 to move away from the rear rail 46. When the front rail 42 is to be held or latched to the rear rail 46, the step 43 of the front rail 42 is moved against a cam portion 26 of the hook portion 18, pushing the hook portion 18 back away from the step 43 of the front rail 42 until the front rail 42 clears the hook 20 of the hook portion 18, whereupon the hook portion 18 no longer being restrained by the step 43 of the front rail 42, under a force bias created in the pinch flex portion 24 by the pinch flex portion 24 being compressed, automatically moves back and catches or latches the step 43 and thus the front rail 42 to the rear rail 46 the without any spring or other component to create the force bias. The latch 10 is one piece.

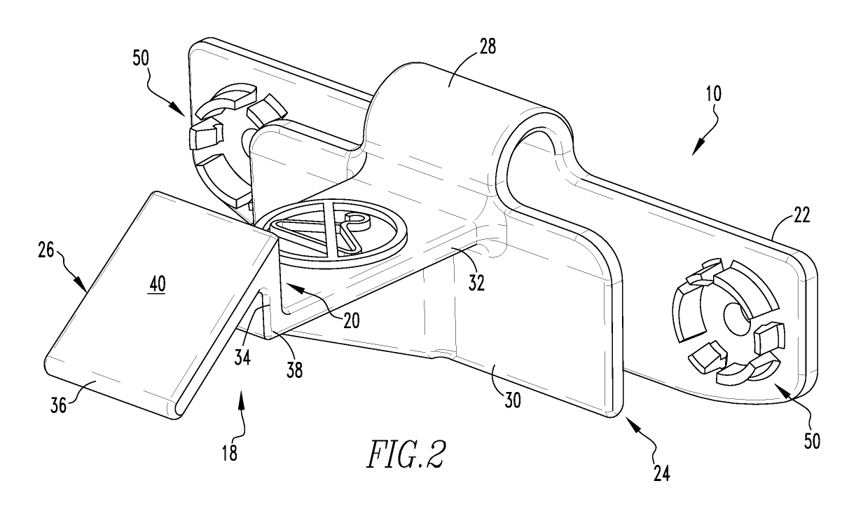

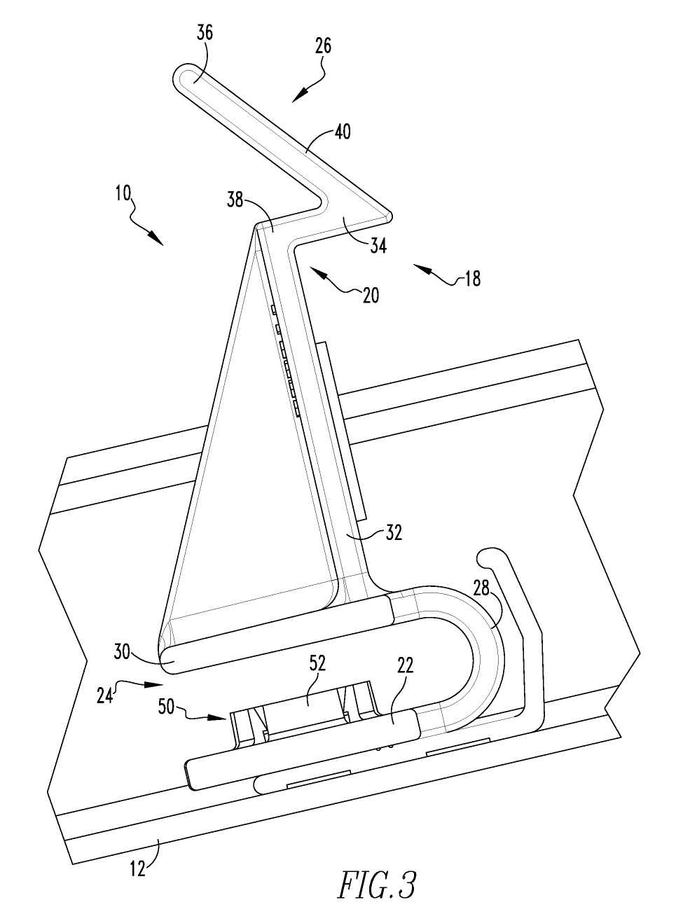

The base portion 22 may have a rivet received portion 50, as shown in FIG. 2, on either end of the base portion 22. A rivet 52 extending through the base portion 22 at each receive portion and the rear rail 46 fixes the latch 10 to the rear rail 46, as shown in FIGS. 3, 4 and 5.

The present invention pertains to a method for latching a front rail 42 of a ladder 48 with a rear rail 46 of the ladder 48. The method comprises the steps of compressing a pinch flex portion 24 of a latch 10 downward toward a base portion 22 of the latch 10 that is fixed to a rigid surface of the rear rail 46 causing a hook portion 18 of the latch 10 to move off of a step 43 attached to the front rail 42, thus releasing the front rail 42 to move away from the rear rail 46. The pinch flex portion 24 is connected to the base portion 22 and the hook portion 18. There is the step of moving the front rail 42 away from the rear rail 46. There is the step of moving the step 43 of the front rail 42 against a cam portion 26 of the hook portion 18, which pushes the hook portion 18 back away from the step 43 of the front rail 42 until the front rail 42 clears the hook 20 of the hook portion 18, whereupon the hook portion 18 no longer being restrained by the step 43 of the front rail 42, under a force bias created in the pinch flex portion 24 by the pinch flex portion 24 being compressed by the step 43, automatically moves back and catches or latches the step 43 and thus the front rail 42 to the rear rail 46 without any spring or other component to create the force bias. The latch 10 is one piece.

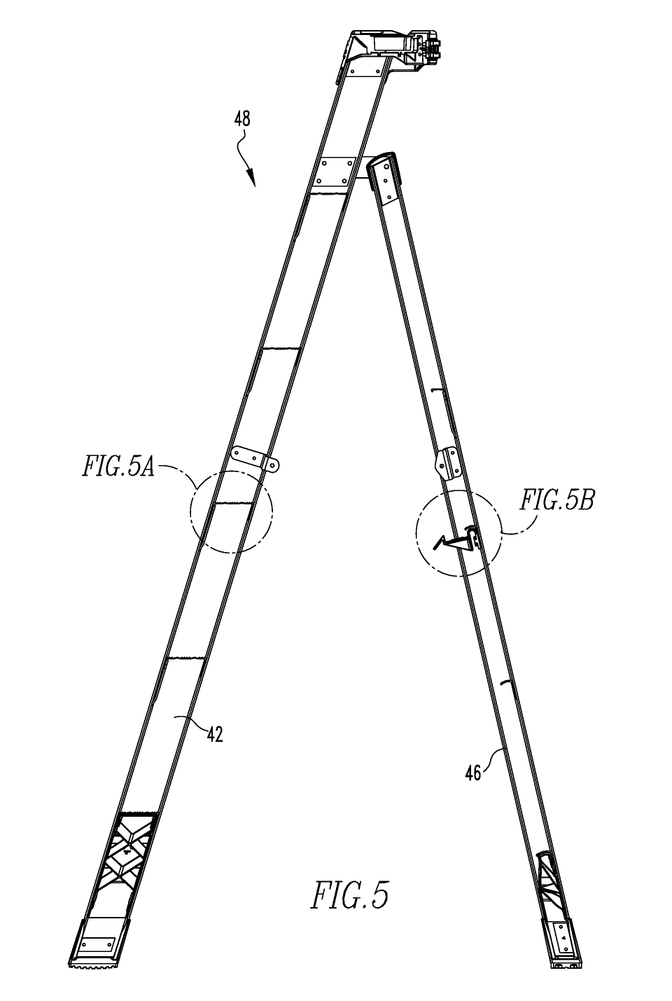

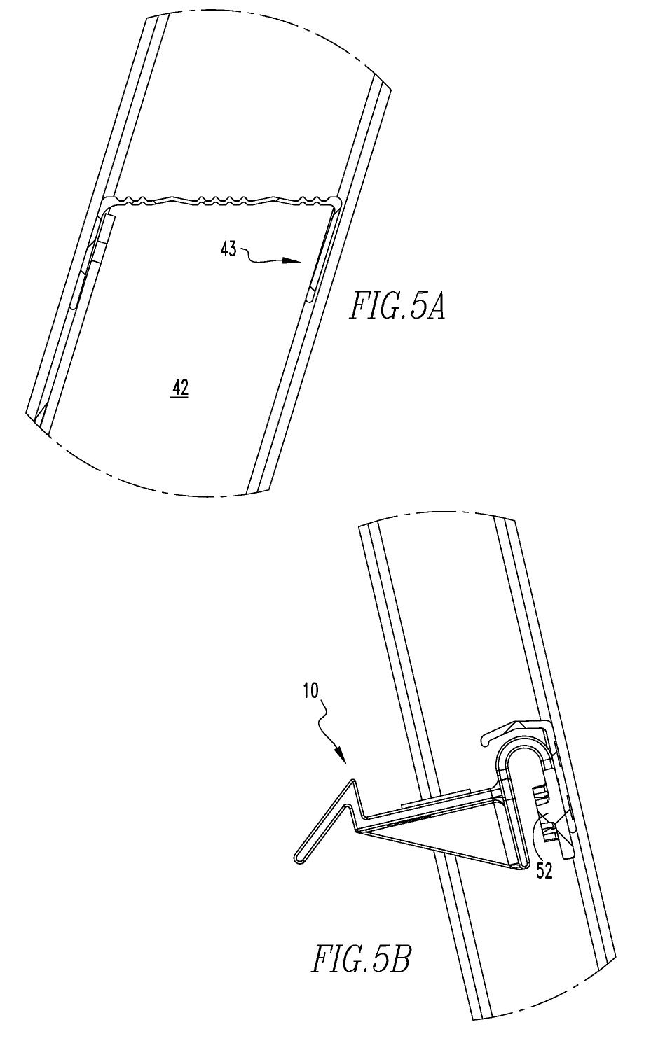

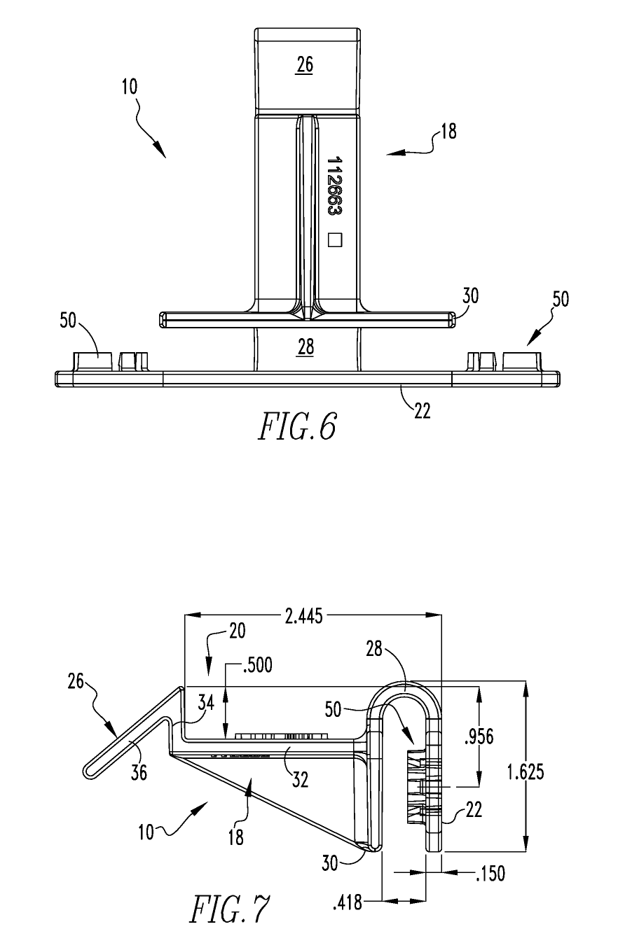

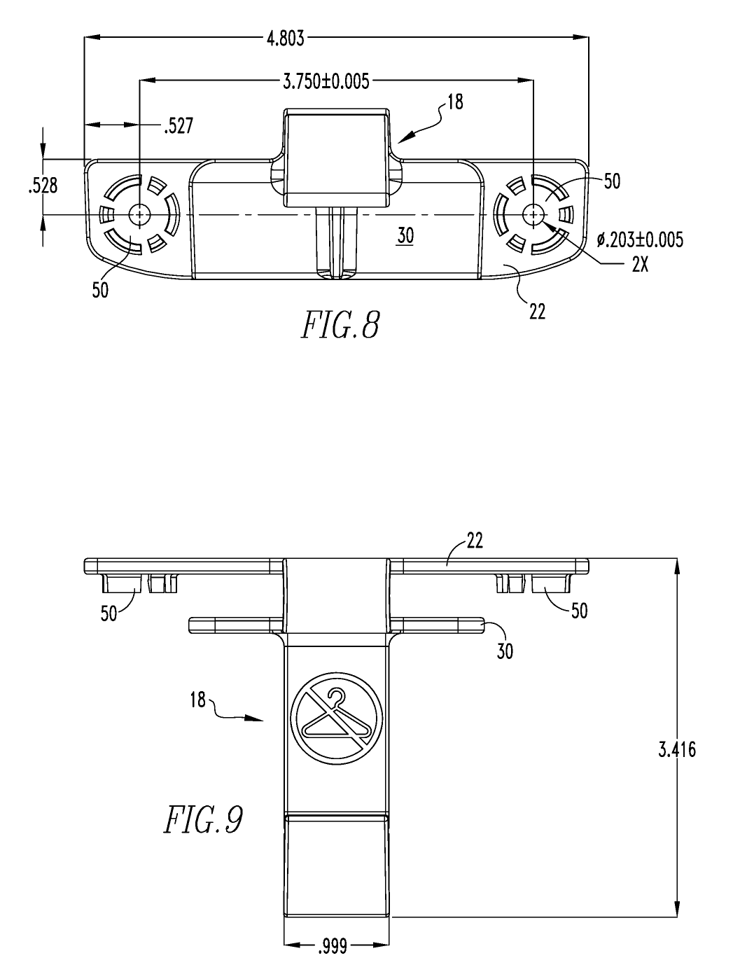

FIGS. 6-9 show different views of the latch 10 as well as dimensions for a preferred embodiment. The thickness of the base portion 22, loop 28, free end 30, first element 32, second element 34 and third element 36 can be between 0.1 inches and 0.4 inches, and preferably 0.15 inches. The height of the latch 10 can be between 3 inches and 6 inches and is preferably about 3.4 inches. The width of the hook portion 18 can be between 0.75 inches and 3 inches and is preferably about 1 inch. The length of the base portion 22 can be between 3 inches and 7 inches and is preferably about 4.8 inches. The width of the base portion 22 can be between 0.75 inches and 3 inches and is preferably about 1 inch wide. The width of the free end 30 is about the same with as the base portion and the length of the free end 30 is between 2 inches and 6 inches preferably about 3 inches. The length of the free end should be such that the rivet receive portions 50 clear the free end 30. The dimensions of the latch 10 may be varied as the requirements dictate with for instance the thickness changing and the other components changing in the corresponding amount.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1: A latch for latching a first object with a second object comprising:
a catch attached to the first object;
a hook portion having a hook which engages with the catch attached to the first object that the latch holds in place;
a base portion that is fixed to a rigid surface of the second object; and
a pinch flex portion connected to the base portion and the hook portion, when the pinch flex portion is compressed or pinch flexed downward to the base portion, the hook portion moves off of the first object, thus releasing the first object to move away from the second object, when the first object is to be held or latched to the second object, the first object is moved against a cam portion of the hook portion, pushing the hook portion back away from the first object until the first object clears the hook of the hook portion, whereupon the hook portion no longer being restrained by the first object, under a force bias created in the pinch flex portion by the pinch flex portion being compressed, automatically moves back and catches or latches the first object to the second object without any spring or other component to create the force bias, the latch is one piece.

2: The latch of claim 1 wherein the pinch flex portion has a loop and a free end that together form a U shape with the base portion, the free end extending from the loop which is able to move up and down and is essentially in parallel with the base portion, when a compressive force is applied to the free end, the free end moves down towards the base portion pivoting at the loop.

3: The latch of claim 2 wherein the hook portion extends outward away from the base portion essentially perpendicularly from the free end.

4: The latch of claim 3 wherein the hook portion includes a first element attached to and extending essentially perpendicularly from the free end outward away from the free end, a second element attached at a connection point to the first element extending essentially perpendicularly from the first element and in parallel with the free end, and a third element attached to the second element extending outward at an acute angle away from the second element and back toward the connection point between the first element in the second element to define a slope, the third element is the cam portion against which the catch pushes back as the first object is moved toward the second object until the catch moves down the slope and clears the second element, whereupon the second element moves back over the catch, the second element and first element forming the hook.

5: A method for latching a first object with a second object comprising the steps of:
compressing a pinch flex portion of a latch downward toward a base portion of the latch that is fixed to a rigid surface of the second object causing a hook portion of the latch to move off of a catch attached to the first object, thus releasing the first object to move away from the second object, the pinch flex portion connected to the base portion and the hook portion;
moving the first object away from the second object; and
moving the first object against a cam portion of the hook portion, which pushes the hook portion back away from the first object until the first object clears the hook of the hook portion, whereupon the hook portion no longer being restrained by the first object, under a force bias created in the pinch flex portion by the pinch flex portion being compressed, automatically moves back and catches or latches the first object to the second object without any spring or other component to create the force bias, the latch is one piece.

6: The method of claim 5 wherein the pinch flex portion has a loop and a free end that together form a U shape with the base portion, the free end extending from the loop which is able to move up and down and is essentially in parallel with the base portion, when a compressive force is applied to the free end, the free end moves down towards the base portion pivoting at the loop.

7: The method of claim 6 wherein the hook portion extends outward away from the base portion essentially perpendicularly from the free end.

8: The method of claim 7 wherein the hook portion includes a first element attached to and extending essentially perpendicularly from the free end outward away from the free end, a second element attached at a connection point to the first element extending essentially perpendicularly from the first element and in parallel with the free end, and a third element attached to the second element extending outward at an acute angle away from the second element and back toward the connection point between the first element in the second element to define a slope, the third element is the cam portion against which the catch pushes back as the first object is moved toward the second object until the catch moves down the slope and clears the second element, whereupon the second element moves back over the catch, the second element and first element forming the hook.

9: A ladder comprising:
a front rail;
a rear rail;
a step attached to the front rail; and
a latch attached to the rear rail and positioned on the rear rail so when the ladder is in a folded position, the latch latches with the step, the latch comprises:
a hook portion having a hook which engages with the step attached to the front rail that the latch holds in place;
a base portion that is fixed to a rigid surface of the rear rail; and
a pinch flex portion connected to the base portion and the hook portion, when the pinch flex portion is compressed or pinch flexed downward to the base portion, the hook portion moves off of the step attached to the front rail, thus releasing the front rail to move away from the rear rail, when the front rail is to be held or latched to the rear rail, the step attached to the front rail is moved against a cam portion of the hook portion, pushing the hook portion back away from the step of the front rail until the front rail clears the hook of the hook portion, whereupon the hook portion no longer being restrained by the step of the front rail, under a force bias created in the pinch flex portion by the pinch flex portion being compressed, automatically moves back and catches or latches the step and thus the front rail to the rear rail without any spring or other component to create the force bias, the latch is one piece.
